(19) United States
(12) Patent Application Publication
(10) Pub. No.: US 2008/0125149 A1
(43) Pub. Date: May 29, 2008

(54) Message delivering telephone ring

(75) Inventor: Sal Terranova, Port Lucie, FL (US)

Correspondence Address: ARTHUR M DULA;LAW OFFICE OF ARTHUR M DULA, 3106 BEAUCHAMP STREET, HOUSTON, TX, 77009, US

(73) Assignee: Coastal Technologies Group, Inc.

(21) Appl. No.: 11/811,666

(22) Filed: Jun. 11, 2007

Related U.S. Application Data
(60) Provisional application No. 60/812,347, filed on Jun. 9, 2006.
(60) Provisional application No. 60/812,438, filed on Jun. 9, 2006.

(51) Int. Cl. H04Q 7/20

(52) U.S. Cl. 455/466

(57) ABSTRACT

A content association system comprising:
a. high speed data network
b. at least one mobile device
c. a program that can:
   i. scan an SMS, recognize an indicator and initiate content retrieval via said high speed data network;
   ii. determine whether content contains relevant metadata;
   iii. perform an association of said content to the desired mobile device application; and
d. a website that can:
   i. embed User identifying fields or data into said content
   ii. send an SMS message to said mobile device listing an Audio/Video/picture file,
   iii. receive a request from said mobile device, and
   iv. send said content to said mobile device.

### CROSS REFERENCE TO RELATED APPLICATIONS

This application is a utility filing that claims the benefit of U.S. Provisional Patent Application No. 60/812,347, entitled “MESSAGE DELIVERING TELEPHONE RING”, filed Jun. 9, 2006 and U.S. Provisional Patent Application No. 60/812,438, entitled “RECORDED VOICE SPECIAL RING DIRECTORY”, filed Jun. 9, 2006, which are herein incorporated by reference.

### BACKGROUND

The invention relates generally to telecommunications, and more particularly to a telephone special ring comprising a voice and/or image message such as a talking caller ID, commercial or event announcement, or a news alert.

Cell phones typically come with multiple ring tones. A user may download additional ring tones and associate ring tones with particular callers.

Currently in the US there are approximately 195 million cell phone users and 2 billion Worldwide (3GSM);

Within the U.S. there are approx. 10 million legally blind/sight impaired people (estimate provided by Michael Kindell of the National Federation of the Blind whom has expressed interest in testing a prototype);

It is projected (3GSM) that the U.S. market for sales of ringtones will exceed $500 million during 2007 and reach $4 billion worldwide.

The Harvard Center for Risk Analysis has published its findings that in excess of 2 million motor vehicle accidents occur in the U.S. annually as the direct result of driver distraction from cell phone usage. This equates to approx. an accident every 15 seconds of every day of the year!

While it is impossible to quantify how many of the aforementioned accidents were the direct result of “trying to see who is calling while driving” there is no discounting that some significant percentage did.

There are companies today that offer ring tones; however, few if any that offer customizable voice tones. In addition, I am not aware of any company that has the capability to automatically update the telephone directory. Also there are some phones that come with a voice synthesized program as well as distinctive ring capability.

There have previously been cellular telephone directories in which caller telephone numbers and associated pictures are stored, some of which also provide special rings. A problem with these systems and programs has been that the owner of the telephone could forget individual special rings and have to pick up the telephone to see who is calling, a practice that frequently leads to traffic accidents.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### DRAWINGS

These and other features, aspects, and advantages of the present invention will become better understood when the following detailed description is read with reference to the accompanying drawings in which like characters represent like parts throughout the drawings, wherein:

FIG. 1 shows a process for associating voice or image data with a caller in accordance with an embodiment of the present invention.

### DETAILED DESCRIPTION

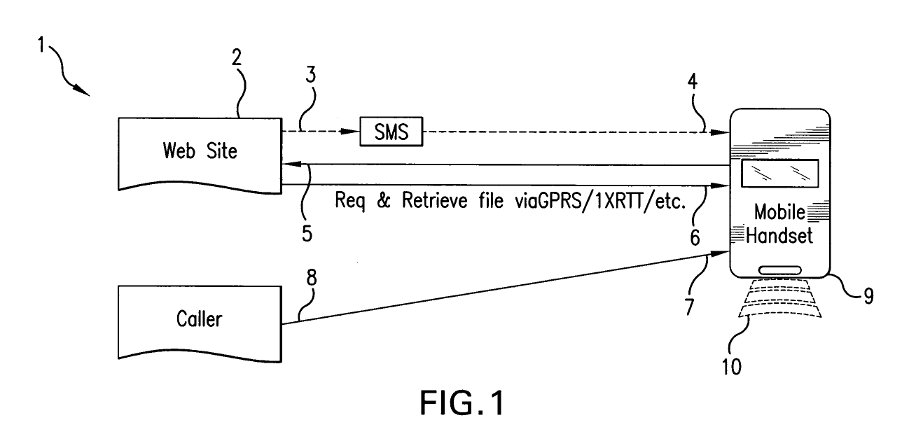

Turning now to FIG. 1, which illustrates a process in accordance with an embodiment of the invention:
1) A user creates Content and enters mobile phone numbers for transfer.
2) Website embeds User identifying fields and data in the Content the user created (metadata).
3) Website Sends SMS message to Mobile phone listing Audio/Video/picture file.
4) Thin client scans SMS, recognizes indicator and initiates Content retrieval via available high speed data network.
5) Website receives request and sends Content to mobile device.
6) Thin Client scans Content metadata for indicators, telephone number, or other.
7) If Thin Client scan finds appropriate metadata it performs an association of that Content to desired mobile handset applications:
   a. In the case of a Phone Book, Thin Client can insert audio file (mp3, amr, etc) names into ring tone listing for a specific phone book entry based on telephone number or name match, or, it can prompt User to create a Phone Book entry based on formatted metadata found. The Thin Client could also insert a Picture Content into Phone Book entry listing. Advanced MMS capable phones could have video and animations associated with specific Phone Book entries.
8) When the mobile phone receives a call, the Calling Party's Caller ID is used by the mobile phone's Operating System to query Phone Book and
9) to play ring tone entries found in matching entries in the Phone Book
10) and display stored pictures or video on the handset screen.

An embodiment of the present invention comprises a telephone special ring directory such as those stored in cellular telephones wherein individual caller voice recordings are substituted for special rings, each voice recording being associated with a particular caller telephone number, so that when a specific caller included in the directory calls, the telephone special ring function plays a recording of the voice of the caller. The recording preferably would give the caller name and ask the receiving party to take the call. One or more telephone rings may be interspersed into the voice recording to help the receiving party recognize and distinguish the voice ring from other sounds such as a voice on the radio. These voice recordings are effectively a talking caller ID, and permit a receiving party to know who is calling and decide which calls to take without reaching for the telephone. Accidents are prevented as a result, because a receiving party is not needlessly distracted while driving.

The voice recordings may be stored in a compressed MP3. A program permitting voice recording substitution for special rings preferably are downloaded from a provider website. The website permits member sign-up and payment arrangements for the program and service. The programs may be a “thin client” residing on the telephone itself and may be JAVA-powered. Many existing simple programs, such as for a game or calculator, can be adopted or adapted to perform the present function. It is contemplated that the program would scan meta-data fields for a telephone number and name, and append to an entry in the telephone for the particular person. A picture of the caller may also be displayed, if the telephone can display pictures.

An optional additional feature would be a program that can remotely destroy the contents of a SIM card in a given telephone in the event the phone is lost or stolen. The “thin client” can also back-up data remotely or to a disk so that data is not lost by intentional destruction of data or by damage to the telephone circuit such as by dropping the telephone in a pool.

Mobile Multimedia File Association Using Metadata:

Process in accordance with an embodiment of the invention to associate a downloaded content (audio, video, picture file) to a specific entry in the mobile phone's directory

Embed user identifiable data in audio/video/picture file metadata at creation [telephone number, user name, account code, coded indicators (ring tone indicator, advertising indicator, Amber Alert indicator), etc]

After audio/video/picture file transfer to phone, use thin client to scan file's metadata.

Associate any downloaded content metadata found to matching phone book entries.

Audio files with telephone and ring tone indicator can be attached to phone book entries as that entry's ring tone.

Picture files with telephone and picture indicator can be attached to phone book entries as that entry's screen displayed picture.

Video/animation files with telephone and video indicator can be attached to MMS capable phone's book entries as that entry's MMS content file If not found, Prompt user to create Phone Book entry based on file metadata and indicators.

Consumer Market:

### Functions:

1) Individual announcement

2) Individualized announcements to share

3) Personalized announcements to share

### Method:

### Caller—audio ring tone—answer.

Business Market:

### Functions:

1) Promotional announcements

2) Advertising to high value target constituents

3) Deliver additional information via recorded message after call answer

4) Display advertisement on handset

### Method:

### Caller—audio ring tone—answer—recorded announcement—picture.

An embodiment of the present invention substitutes an audio message for a ring tone. Examples of such audio messages include commercial or event announcements or news alerts. The incoming ring tone message may be accompanied by a related message that the receiving party can hear by answering the telephone.

Optionally, the present invention may permit the receiving party to make a purchase relating to the ring tone audio message by responding to a series of prompts or can otherwise conclude a commercial transaction.

In accordance with an embodiment of the present invention, the receiving party can have the related message recorded on voice mail by not answering the telephone.

The telephone preferably is a cellular telephone, but may be other types of telephones as well. Where a commercial announcement is a ticket sale for a performance, the announcement preferably is made in the voice of the performer. Event messages might include club or fraternity announcements. A news alert might be what is known in news as an Amber Alert, for example. The receiving party preferably subscribes or otherwise opts into the system to receive such messages, so that only willing and interested individuals receive the calls. The message delivery option might be bundled with other provider services.

In accordance with an embodiment of the present invention, a residential customer, through either/or a Web site or directly from their cell phone, will have the ability to create voice messages (for example: MP3, WAV) and software can automatically associate the ring tone to their cell phone address book. Hence, when they receive a call from anyone in their address book they will hear, instead of a ring, the name and number of the person calling them in either their voice (basic plan) or the callers (premium) . . . without looking at the phone.

Example: “this is Rose calling from my cell phone”.

An embodiment of the present invention accords the retail advertising segment, affinity groups (clubs, associations, et al) a new method of advertising or of making public broadcast announcements (Amber Alerts, evacuation notices).

For example, retail advertisers, affinity groups, etc. could notify their customers/members that they are offering a new free-of-charge method of advising them of unadvertised store sales, special events, appearances, Amber Alerts, etc. Preferably, in order for them to receive “broadcast” ring tones the customers/members must “opt in” by, for example, pressing a button on their phone or visiting a web site. They could receive instructions on how to use the system. Alternately, tools could automate the entry in their cell phone directory for whatever the entry is. When the advertiser is ready to commence a campaign, the message is sent to the user community.

Example: “This is Macy's calling about a special sale event for our loyal customers.” Once the call is answered a message could be played advising of the details.

In accordance with an embodiment of the present invention, the system could use 10 digit reverse look-up to associate a voice ring tone and/or image with an incoming call.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A process for associating content with a phone number comprising the steps:
a) A user creates Content and enters mobile phone numbers for transfer;
b) A Website embeds User identifying fields and data into said Content;
c) Said Website sends an SMS message to a mobile device listing an audio or video or picture file;
d) A Thin Client scans the SMS, recognizes an indicator and initiates Content retrieval via available high speed data network;
e) Said Website receives the request and sends said Content to said mobile device;
f) Said Thin Client scans said Content metadata for indicators, telephone number, or other; and
g) If said Thin Client scan finds appropriate metadata, said Thin Client performs an association of said Content to the desired mobile handset applications.

2. The process of claim 1 further comprising the step: said Thin Client inserts audio file names into a ring tone listing for a specific phone book entry based on telephone number or name match.

3. The process of claim 1 further comprising the step: said Thin Client prompts User to create a Phone Book entry based on said formatted metadata found.

4. The process of claim 1 further comprising the step: said Thin Client inserts Picture Content into a Phone Book entry listing.

5. The process of claim 1 further comprising the step: when said mobile device receives a call, the Calling Party's Caller ID is used by the said mobile device's Operating System to query the Phone Book and to play ring tone entries found in matching entries in said Phone Book.

6. The process of claim 1 further comprising the step: when said mobile device receives a call, the Calling Party's Caller ID is used by the mobile device's Operating System to query Phone Book display stored pictures or video on the handset screen.

7. A content association system comprising:
a. high speed data network
b. at least one mobile device
c. a program that can:
i. scan an SMS, recognize an indicator and initiate content retrieval via said high speed data network;
ii. determine whether content contains relevant metadata;
iii. perform an association of said content to the desired mobile device application; and
d. a website that can:
i. embed User identifying fields or data into said content
ii. send an SMS message to said mobile device listing an Audio/Video/picture file,
iii. receive a request from said mobile device, and
iv. send said content to said mobile device.

8. The content association system of claim 7 wherein said program comprises a thin client residing on said mobile device that associates audio content with specific phone book entries.

9. The content association system of claim 8 wherein said thin client can be downloaded to said mobile device.

10. The content association system of claim 7 wherein said mobile device comprises an advanced MMS capable phone and said program comprises a thin client that associates video and animations with specific phone book entries.

11. The content association system of claim 7 wherein said program comprises a thin client that inserts audio file names into a ring tone listing for a specific phone book entry based on telephone number or name match.

12. The content association system of claim 7 wherein said program comprises a thin client that inserts Picture Content into a phone book entry listing.

13. The content association system of claim 7 wherein said program comprises a thin client that prompts a mobile device user to create a phone book entry based on formatted metadata found.

14. The Content association system of claim 7 wherein said website comprises means for member sign-up and payment arrangements for the program and service.

15. The Content association system of claim 7 wherein said mobile device comprises a thin client that is JAVA-powered.

16. The Content association system of claim 7 wherein said program can remotely destroy the contents of a SIM card in said mobile device.

17. The Content association system of claim 7 wherein said mobile device comprises a thin client that can back-up data remotely or to a disk.

18. The Content association system of claim 7 wherein said mobile device can be used to make a purchase related to said content by responding to a series of prompts or can otherwise conclude a commercial transaction.

19. The Content association system of claim 18 wherein said purchase or commercial transaction is a ticket sale for a performance.

20. The Content association system of claim 19 wherein said content comprises a ring tone audio message made in the voice of a performer.

21. The Content association system of claim 7 wherein said content comprises a ring tone message that is accompanied by a related message that the receiving party can hear by answering the telephone.

22. The Content association system of claim 21 wherein said related message may be recorded on voice mail by not answering the telephone.

23. The Content association system of claim 7 wherein said content comprises news alert or public broadcast announcement.

24. The Content association system of claim 7 wherein said program further comprises reverse look-up that can be used to associate content with incoming calls.

25. A telephone special ring directory comprising at least one individual caller voice recording.

26. The telephone special ring directory of claim 25 wherein said individual caller voice recordings is associated with a particular caller telephone number, such that when a said caller calls, a recording of the voice of the caller is heard.

27. The telephone special ring directory of claim 25 wherein one or more telephone rings are interspersed into said voice recording.

28. The telephone special ring directory of claim 25 wherein said voice recordings are stored in MP3 format.

29. The telephone special ring directory of claim 26 further comprising at least one image file that is associated with said caller telephone number, such that when said caller calls, said image file is displayed.
